(19) United States
(12) Patent Application Publication
(10) Pub. No.: US 2021/0303987 A1
(43) Pub. Date: Sep. 30, 2021

(54) POWER REDUCTION FOR MACHINE LEARNING ACCELERATOR BACKGROUND

(71) Applicant: Advanced Micro Devices, Inc., Santa Clara, CA (US)

(72) Inventors: Maxim V. Kazakov, San Diego, CA (US); Samuel Lawrence Wasmundt, San Diego, CA (US)

(73) Assignee: Advanced Micro Devices, Inc., Santa Clara, CA (US)

(21) Appl. No.: 16/831,711

(22) Filed: Mar. 26, 2020

(51) Int. Cl. G06N 3/08; G06N 3/04

(52) U.S. Cl. CPC G06N 3/08; G06N 3/04

(57) ABSTRACT

A technique for performing neural network operations is disclosed. The technique includes identifying a first matrix tile and a second matrix tile, obtaining first range information for the first matrix tile and second range information for the second matrix tile, selecting a matrix multiplication path based on the first range information and the second range information, and performing a matrix multiplication on the first matrix tile and the second matrix tile using the selected matrix multiplication path to generate a tile matrix multiplication product.

### BACKGROUND

Machine learning systems process inputs through a trained network to generate outputs. Due to the amount of data processed and the complexities of the networks, such evaluations involve a very large number of calculations.

### BRIEF DESCRIPTION OF THE DRAWINGS

A more detailed understanding may be had from the following description, given by way of example in conjunction with the accompanying drawings wherein:

FIG. 1 is a block diagram of a neural network processing system according to an example;

FIG. 2 is an example block diagram illustrating neural network data;

FIG. 3 is a block diagram of the neural network processing block of FIG. 1, showing additional detail, according to an example;

FIG. 4 illustrates matrix multiplication operations related to a generic neuron layer, according to an example;

FIG. 5 illustrates a convolution operation, according to an example;

FIG. 6 illustrates a batched, multi-channel convolution operation, according to an example;

FIG. 7 illustrates an example way in which a multi-channel, batched convolution is performed as a matrix multiplication operation; and

FIG. 8 is a flow diagram of a method for performing matrix operations, according to an example.

### DETAILED DESCRIPTION

A technique for performing neural network operations is disclosed. The technique includes identifying a first matrix tile and a second matrix tile; obtaining first range information for the first matrix tile and second range information for the second matrix tile; selecting a matrix multiplication path based on the first range information and the second range information; and performing a matrix multiplication on the first matrix tile and the second matrix tile using the selected matrix multiplication path to generate a tile matrix multiplication product.

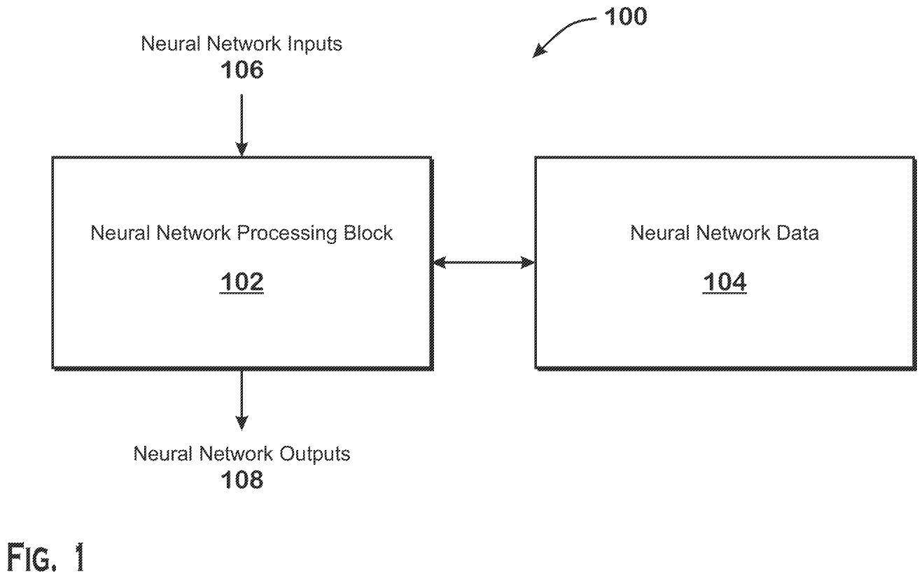

FIG. 1 is a block diagram of a neural network processing system 100 according to an example. The neural network processing system includes a neural network processing block 102 and neural network data 104. The neural network processing block 102 is embodied as hardware circuitry that performs the operations described herein, software executing on a processor to perform the operations described herein, or a combination of hardware circuitry and software executing on a processor that performs the operations described herein.

In operation, the neural network processing block 102 receives neural network inputs 106, processes the neural network inputs 106 according to the neural network data 104 to generate neural network outputs 108, and outputs the neural network outputs 108.

In some examples, the neural network processing block 102 is or is included within a computer system that includes one or more processors that read and execute instructions to perform the operations described herein. In some implementations, any such processor (or any processor described within this document) includes instruction fetch circuitry to fetch instructions from one or more memories, data fetch circuitry to fetch data from one or more memories, and instruction execution circuitry to execute instructions. In various examples, the one or more processors of the neural network processing block 102 are coupled to one or more input devices and/or one or more output devices that input data and output data for the one or more processors. The neural network data 104 includes data that defines one or more neural networks through which the neural network processing block 102 processes the neural network inputs 106 to generate the neural network outputs 108.

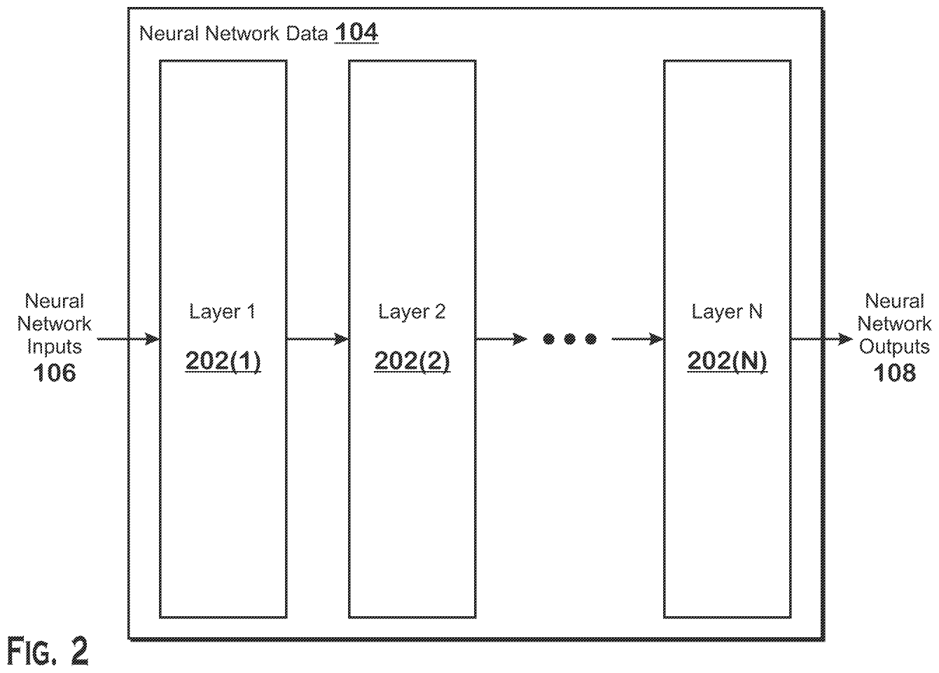

FIG. 2 is an example block diagram illustrating neural network data 104. The neural network data 104 includes a sequence of layers 202 through which data flows. The neural network data 104 is sometimes referred to herein simply as a “neural network 104,” since the data represents the sequence of neural network operations performed on inputs to generate outputs. The neural network processing block 102 applies the neural network inputs 106 to the layers 202, which apply respective layer transforms to produce the neural network outputs 108. Each layer has its own layer transform applied to the input received by that layer 202 to generate output from that layer 202 to the next layer or as the neural network outputs 108 for the final layer 202(N). The neural network data 104 defines a neural network as the number of layers 202, and the specific transform at each layer 202. Example transforms include generic neuron layers, in which each of a plurality of neurons in a layer 202 has defined connectivity to outputs from the previous layer 202, single-element transformations, convolutional layers, and pooling layers. More specifically, as described above, each layer 202 receives an input vector from the previous layer 202. Some layers 202 include a set of neurons, where each such neuron receives a defined subset of the input vector or that entire vector. Further, each such neuron has a weight applied to each such input. Further, the activation of each neuron is the sum of the product of the input value at each input with the weight at each input (and thus each such activation is the dot product of the input vector of that neuron and the weight vector of that neuron).

A layer 202 that applies a single-element transformation receives the input vector and applies some defined transform on each element of that input vector. Example transforms include a clamping function, or some other non-linear function. A layer 202 that applies pooling performs a down-sample on the input vector to create an output vector of a smaller size than the input vector, based on a down-sampling function that down-samples inputs in any technically feasible manner. A layer 202 that applies a convolution applies a convolution operation, in which a dot-product is applied to filter cutouts of the input data and a filter vector to generate the outputs.

Several types of layer operations, such as the generic neuron layers and the convolutional layers are implemented with matrix multiplication. More specifically, because the calculation of the activation function of neurons in generic neuron layers are dot products, such calculation can be implemented as a set of dot product operations defined by a matrix multiplication. Similarly, because the application of a filter in a convolution operation is performed with a dot product, a matrix multiplication operation can be used to implement convolutional layers. Large matrix multiplication operations involving floating point numbers can consume a large amount of power due to the complexities and number of floating point multiplication operations performed. Therefore, techniques are provided herein that reduce power usage in certain situations.

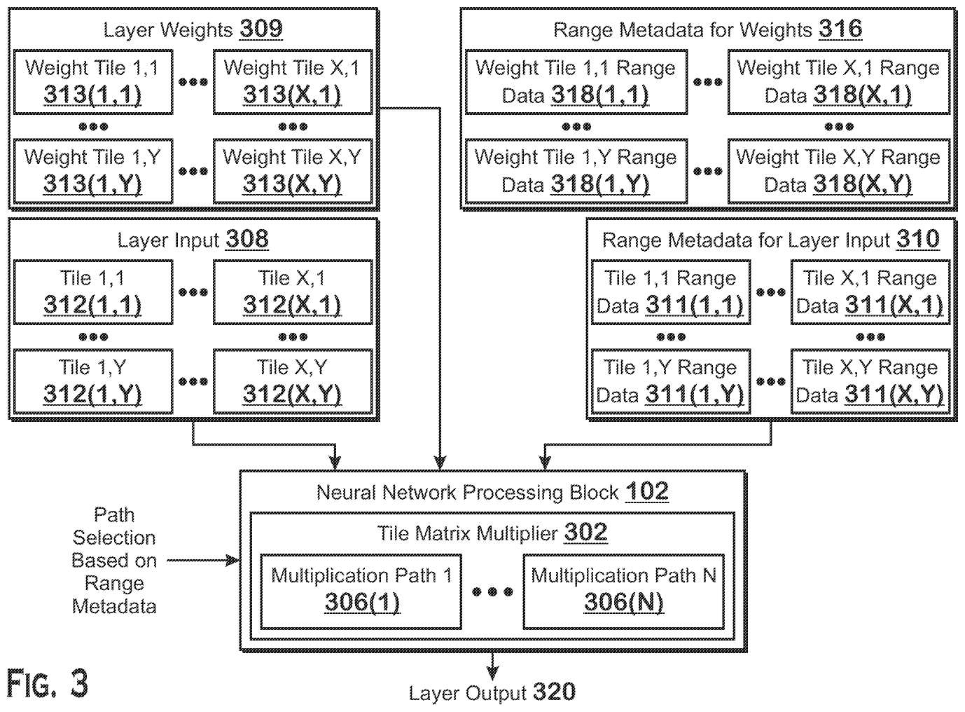

FIG. 3 is a block diagram of the neural network processing block 102 of FIG. 1, showing additional detail, according to an example. The neural network processing block 102 includes a tile matrix multiplier 302 which the neural network processing block 102 uses to perform matrix multiplication for layers 202 that use matrix multiplication.

In the course of performing matrix multiplication for a layer 202, the neural network processing block 102 receives layer input 308 and layer weights 309 and generates or receives range metadata for the layer input 310 and range metadata for the weights 316. The layer input 308 includes the inputs for a particular layer 202 that uses matrix multiplication. The layer weights 309 include neuron connection weights for generic neuron layers or filter weights for convolution layers. The layer input 308 includes a set of layer input tiles 312, each of which are portions of an input matrix representing layer input. The layer weights 309 are the set of weights for the layer, divided into weight tiles 313. The range metadata for the weights 316 include range metadata for each weight tile 318. Each item of range metadata indicates a range for a corresponding weight tile 313. The range metadata for layer input 310 includes range metadata for each layer input tile 312. Each item of layer input metadata indicates a range for a corresponding layer input tile 312.

The ranges (weight ranges 318 and input ranges 311) indicate a range of values for the corresponding weight tile 313 or input tile 312. In an example, the range for a particular tile is −1 to 1, meaning that all elements of the tile are between −1 and 1. In another example, a range is −256 to 256, and in another example, a range is the full range (i.e., the maximum range that can be expressed by the data items of the weights).

When performing matrix multiplication of the layer weights 309 by the layer input 308, the tile matrix multiplier 302 performs matrix multiplication of layer input tiles 312 by layer weight tiles 313 to generate partial matrix products and combines the partial matrix products to generate layer output 320. The specific layer input tiles 312 and weight tiles 313 that are multiplied together to generate the partial products, and the ways in which those partial products are combined to generate the layer output 320, are dictated by the nature of the layer. Some examples are illustrated in other portions of this description.

In performing a specific multiplication of a layer input tile 312 by a weight tile 313, the tile matrix multiplier examines the range metadata for the weight tile 318 and the range metadata for the input tile 311 and selects a multiplication path 306 to perform that multiplication. Different multiplication paths 306 are configured for different combinations of ranges, where a combination is defined as a range of a layer input tile 311 and a range of a weight tile 318. A multiplication path 306 that is configured for a combination of more limited ranges consumes less power than a multiplication path 306 that is configured for a combination of a broader set of ranges. A multiplication path 306 is a circuit configured to perform matrix multiplication for two matrices of at most a fixed size. It is possible to multiply two matrices larger than this size together using the multiplication paths 306 using a tiled multiplication approach described elsewhere herein. In brief, this tiled multiplication approach involves dividing the input matrices into tiles, multiplying these tiles together to generate partial products, and summing the partial products to generate the final output matrices. In some implementations, each multiplication path 306 is configured for the same sizes of multiplicand matrices.

The power reduction for multiplication paths 306 for more limited ranges is accomplished through simpler circuitry. In an example, matrix multiplication involves performing dot products, which involves multiplying dot product multiplicands to generate partial dot products and summing the partial dot products to generate a final dot product. The exponents of the partial dot products ultimately determine which partial dot products are discarded when summing the partial dot products, as partial dot products with a small enough exponent will be sufficiently smaller than the smallest unit representable by the partial product with the largest exponent and therefore would not contribute to the final dot product. To facilitate this discard, at least some of the multiplication paths 306 include circuitry for comparing the exponents of the partial dot products to determine which partial dot products to discard. However, this comparison consumes power. Utilizing range metadata allows a smaller number of exponent comparisons to be made in the case that one or both of the weight tile 313 and the input tile 312 fit within a particular range. Thus, when the tile matrix multiplier 302 performs a multiplication of a weight tile 313 by an input tile 312 to generate a partial matrix product, the tile matrix multiplier 302 examines the input tile range 311 for the input tile 312 and the weight tile range 318 for the weight tile 313 and selects a multiplication path 306 appropriate for those ranges.

The neural network processing block 102 performs processing with the neural network 104 in the following manner. The neural network processing block 102 receives inputs 106 to the neural network 104 and provides those inputs to the first layer 202. The neural network processing block 102 processes those inputs at that layer 202 to generate outputs and provides those outputs to the next layer 202, continuing this processing until the neural network processing block 102 generates the neural network outputs 108. For one or more layers 202 implemented via matrix multiplication (such as generic neuron layers or convolutional layers), the neural network processing block 102 generates or obtains range data (including, for example, the range metadata for weights 316 and/or the range metadata for layer input 310) for the matrices to be multiplied and performs the matrix multiplications using multiplication paths 306 selected based on that range metadata. In some implementations, the neural network processing block 102 obtains or generates this range metadata without intervention from an external processor such as a CPU (central processing unit) (which in some implementations executes an operating system). In some implementations, the neural network processing block 102 automatically obtains or generates this range metadata. In some implementations, the neural network processing block 102 obtains or generates this metadata without being instructed to do so by a processor that is not part of the neural network processing block 102. In some implementations, the neural network processing block 102 obtains or generates this metadata for inputs to a layer 202 without transferring those inputs to a memory that is external to the neural network processing block 102. More specifically, in some implementations, a CPU or other processor reads the output data generated by a layer 202 into a memory accessible by the CPU or other processor, generates range metadata for that output data, and provides the range metadata to the subsequent layer 202. In some implementations, the neural network processing block 102 performs this range metadata generation without intervention by the CPU or other processor and without requiring that the output data be read into the memory accessible by the CPU or other processor.

In some implementations, the neural network processing block 102 does not generate the range metadata for weights 316 while processing inputs through a neural network 104. Instead, the neural network processing block 102 generates the range metadata for weights 316 prior to processing inputs through a neural network 104, since the weights 316 are static for any particular instance of processing inputs through the neural network 104. When inputs for a layer 202 that is implemented with matrix multiplication are fetched, the neural network processing block 102 fetches the pre-generated range data for the weights for that layer and obtains the range metadata for the layer input 310 for that layer 202.

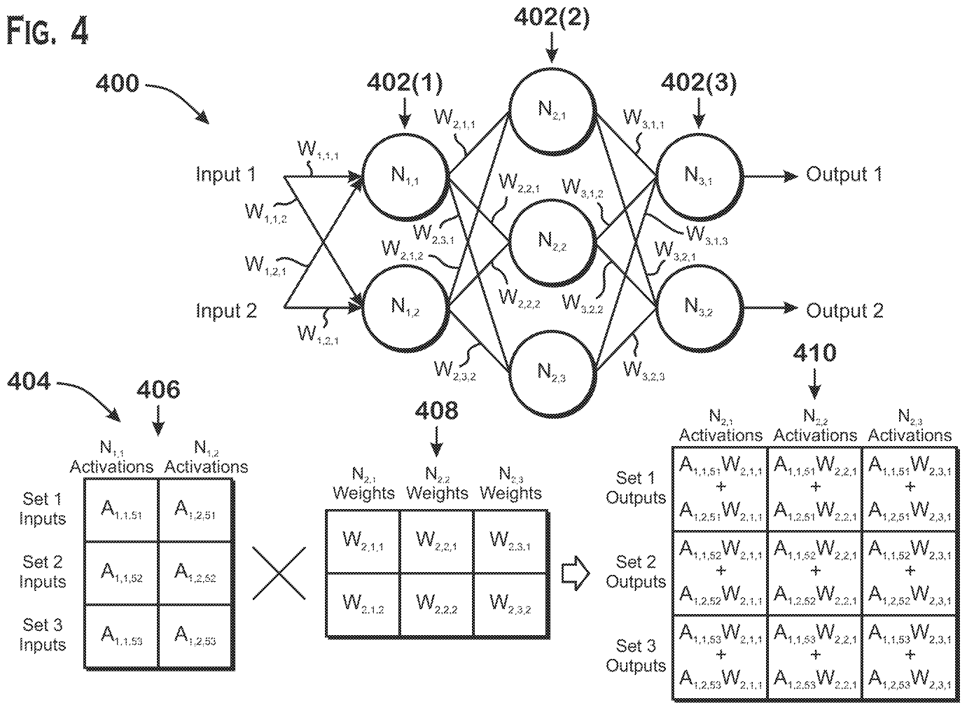

FIG. 4 illustrates matrix multiplication operations related to a generic neuron layer, according to an example. Any of the layers 202 are implementable as a generic neuron layer. An illustrative neural network portion 400 includes a first neuron layer 402(1), a second neuron layer 402(2), and a third neuron layer 402(3). In the first neuron layer 402(1), neuron N_{1,1} applies weight W_{1,1,1} to Input 1 and applies W_{1,2,1} to input 2 to generate an activation output as W_{1,1,1}*Input1+W_{1,2,1}*Input2. Similarly, neuron N1,2 generates output as W_{1,1,2}*Input1+W_{1,2,1}*Input2. Activations for the other neuron layers 402 are calculated similarly with the weights and inputs shown.

FIG. 4 shows matrix multiplication operations for the second neuron layer 402(2), for multiple sets (or batches) of inputs. A set of inputs is an independent instance of input data. Referring back to FIG. 2 momentarily, it is possible to apply multiple different sets of neural network input data 106 to the neural network data 104 at the same time to generate multiple sets of neural network outputs 108, which allows multiple neural network forward propagation operations to be performed in parallel.

In FIG. 4, the matrix multiplication 404 operation is shown for three different sets of input data. The first matrix 406 illustrated is the matrix of inputs to the neurons of the layer 402(2). These inputs are referred to as the activations of the previous neurons illustrated, specifically N_{1,1} activations and N_{1,2} activations. The input matrix 406 thus includes activations from neurons N_{1,1} and N_{1,2} for the three different sets. The notation for those activations are A_{X,Y,Z}, with X and Y defining the neuron and Z defining the input set. The second matrix 408 includes the weights of the connections between the neurons of the first layer 402(1) and the neurons of the second layer 402(2). The weights are represented as W_{X,Y,Z}, with X and Y representing the neuron to which the weight points and Z representing the neuron from which the weight originates.

The matrix multiplication includes performing dot products of each of the rows of the input by the columns of the weight matrix to obtain the activations matrix 410. Each row of the activations matrix corresponds to a different set of inputs and each column corresponds to a different neuron of layer 402(2), with dot products produced as illustrated.

As stated above, the tile matrix multiplier 302 multiplies matrices by decomposing the matrices into tiles, multiplying the tiles together to generate partial matrix products, and summing the partial matrix products to generate the final output matrix. The tile matrix multiplier 302 selects a multiplication path 306 for each tile-to-tile multiplication based on the appropriate range metadata.

An example of how to multiply large matrices by dividing those large matrices into smaller matrices (tiles) is now provided.

TABLE 1
Example matrix multiplication
$\begin{matrix}{a}_{1 , 1} & {a}_{2 , 1} & {a}_{3 , 1} & {a}_{4 , 1} \\ {a}_{1 , 2} & {a}_{2 , 2} & {a}_{3 , 2} & {a}_{4 , 2} \\ {a}_{1 , 3} & {a}_{2 , 3} & {a}_{3 , 3} & {a}_{4 , 3} \\ {a}_{1 , 4} & {a}_{2 , 4} & {a}_{3 , 4} & {a}_{4 , 4}\end{matrix} \times \begin{matrix}{b}_{1 , 1} & {b}_{2 , 1} & {b}_{3 , 1} & {b}_{4 , 1} \\ {b}_{1 , 2} & {b}_{2 , 2} & {b}_{3 , 2} & {b}_{4 , 2} \\ {b}_{1 , 3} & {b}_{2 , 3} & {b}_{3 , 3} & {b}_{4 , 3} \\ {b}_{1 , 4} & {b}_{2 , 4} & {b}_{3 , 4} & {b}_{4 , 4}\end{matrix} =$

| | | | |
|---|---|---|---|
| a_{1,1}b_{1,1} + a_{2,1}b_{1,2} + | a_{1,1}b_{2,1} + a_{2,1}b_{2,2} + | a_{1,1}b_{3,1} + a_{2,1}b_{3,2} + | a_{1,1}b_{4,1} + a_{2,1}b_{4,2} + |
| a_{3,1}b_{1,3} + a_{4,1}b_{1,4} | a_{3,1}b_{2,3} + a_{4,1}b_{2,4} | a_{3,1}b_{3,3} + a_{4,1}b_{3,4} | a_{3,1}b_{4,3} + a_{4,1}b_{4,4} |
| a_{1,2}b_{1,1} + a_{2,2}b_{1,2} + | a_{1,2}b_{2,1} + a_{2,2}b_{2,2} + | a_{1,2}b_{3,1} + a_{2,2}b_{3,2} + | a_{1,2}b_{4,1} + a_{2,2}b_{4,2} + |
| a_{3,2}b_{1,3} + a_{4,2}b_{1,4} | a_{3,2}b_{2,3} + a_{4,2}b_{2,4} | a_{3,2}b_{3,3} + a_{4,2}b_{3,4} | a_{3,2}b_{4,3} + a_{4,2}b_{4,4} |
| a_{1,3}b_{1,1} + a_{2,3}b_{1,2} + | a_{1,3}b_{2,1} + a_{2,3}b_{2,2} + | a_{1,3}b_{3,1} + a_{2,3}b_{3,2} + | a_{1,3}b_{4,1} + a_{2,3}b_{4,2} + |
| a_{3,3}b_{1,3} + a_{4,3}b_{1,4} | a_{3,3}b_{2,3} + a_{4,3}b_{2,4} | a_{3,3}b_{3,3} + a_{4,3}b_{3,4} | a_{3,3}b_{4,3} + a_{4,3}b_{4,4} |
| a_{1,4}b_{1,1} + a_{2,4}b_{1,2} + | a_{1,4}b_{2,1} + a_{2,4}b_{2,2} + | a_{1,4}b_{3,1} + a_{2,4}b_{3,2} + | a_{1,4}b_{4,1} + a_{2,4}b_{4,2} + |
| a_{3,4}b_{1,3} + a_{4,4}b_{1,4} | a_{3,4}b_{2,3} + a_{4,4}b_{2,4} | a_{3,4}b_{3,3} + a_{4,4}b_{3,4} | a_{3,4}b_{4,3} + a_{4,4}b_{4,4} |

As shown above, in a matrix multiplication operation, an element having x,y coordinates in the matrix product is generated by generating the dot product of the X'th row of the first matrix with the Y'th column of the second matrix. The same matrix multiplication can be performed in a tiled manner by dividing each of the multiplicand matrices into tiles, and, treating each tile as an element of “coarse” multiplicand matrices, performing matrix multiplication on these “coarse” matrices. Each element, having coordinates x,y, of the product of such coarse matrices is a matrix resulting from the “coarse dot product” of the X'th row of the first coarse matrix with the Y'th column of the second coarse matrix. A coarse dot product is the same as a dot product, except that multiplication is replaced with matrix multiplication and addition is replaced with matrix addition. Because such dot products involve the matrix multiplication of two tiles, this multiplication is mappable onto hardware that performs tile-by-tile matrix multiplication to generate partial matrix products and then adds those partial matrix products to arrive at the final product. The tile matrix multiplier 302 performs the above operations to multiply tiled multiplicand matrices, using the stored range metadata to select multiplication paths 306 for each tile-by-tile matrix multiplication.

In the following example, the matrix multiplication of Table 1 is performed in a tiled manner. The matrix multiplication:

$$\begin{matrix}{a}_{1 , 1} & {a}_{2 , 1} & {a}_{3 , 1} & {a}_{4 , 1} \\ {a}_{1 , 2} & {a}_{2 , 2} & {a}_{3 , 2} & {a}_{4 , 2} \\ {a}_{1 , 3} & {a}_{2 , 3} & {a}_{3 , 3} & {a}_{4 , 3} \\ {a}_{1 , 4} & {a}_{2 , 4} & {a}_{3 , 4} & {a}_{4 , 4}\end{matrix} \times \begin{matrix}{b}_{1 , 1} & {b}_{2 , 1} & {b}_{3 , 1} & {b}_{4 , 1} \\ {b}_{1 , 2} & {b}_{2 , 2} & {b}_{3 , 2} & {b}_{4 , 2} \\ {b}_{1 , 3} & {b}_{2 , 3} & {b}_{3 , 3} & {b}_{4 , 3} \\ {b}_{1 , 4} & {b}_{2 , 4} & {b}_{3 , 4} & {b}_{4 , 4}\end{matrix}$$

can be expressed as:

$$\begin{matrix}{M}_{1 , 1} & {M}_{2 , 1} \\ {M}_{1 , 2} & {M}_{2 , 2}\end{matrix} \times \begin{matrix}{N}_{1 , 1} & {N}_{2 , 1} \\ {N}_{1 , 2} & {N}_{2 , 2}\end{matrix}$$

where the M and N elements are tiles and:

TABLE 2
Tiled matrix multiplication

M_{1, 1} = _{α}_{_{1, 2}}^{α}^{^{1, 1}}_{α}^{_{2, 2}}^{α}^{^{2, 1}}, M_{2, 1} = _{α}_{_{3, 2}}^{α}^{^{3, 1}}_{α}^{_{4, 2}}^{α}^{^{4, 1}}, M_{1, 2} = _{α}_{_{1, 4}}^{α}^{^{1, 3}}_{α}^{_{2, 4}}^{α}^{^{2, 3}}, M_{2, 2} = _{α}_{_{3, 4}}^{α}^{^{3, 3}}_{α}^{_{4, 4}}^{α}^{^{4, 3}}; and
N_{1, 1} = _{b}_{_{1, 2}}^{b}^{^{1, 1}} _{b}_{_{2, 2}}^{b}^{^{2, 1}}, N_{2, 1} = _{b}_{_{3, 2}}^{b}^{^{3, 1}} _{b}_{_{4, 2}}^{b}^{^{4, 1}}, N_{1, 2} = _{b}_{_{1, 4}}^{b}^{^{1, 3}} ₙ_{_{2, 4}}^{b}^{^{2, 3}}, N_{2, 2} = _{b}_{_{3, 4}}^{b}^{^{3, 3}} _{b}_{_{4, 4}} ^{b}^{^{4, 3}}.

The matrix product can thus be expressed as:

M_{1,1}N_{1,1}+M_{2,1}N_{1,2} M_{1,1}N_{2,1}+M_{2,1}N_{2,2}

M_{1,2}N_{1,1}+M_{2,2}N_{1,2} M_{1,2}N_{2,1}+M_{2,2}N_{2,2}

in which each element is the sum of matrix products of tiles. Multiplying an M tile by an N tile is done through standard matrix multiplication. The above illustrates how a matrix multiplication of two 4×4 matrices can be performed by dividing the matrices into 2×2 tiles, multiplying those matrices to generate partial matrix products, and summing the partial matrix products to generate the final matrix product. In some implementations, for a general neuron matrix multiplication of the type described in FIG. 4, the weight tiles 313 and input tiles 312 represent the division of the weight matrix and the input matrix (for one or more sets of inputs) into tiles. The range metadata of FIG. 3 is specified for each tile (M tile or N tile).

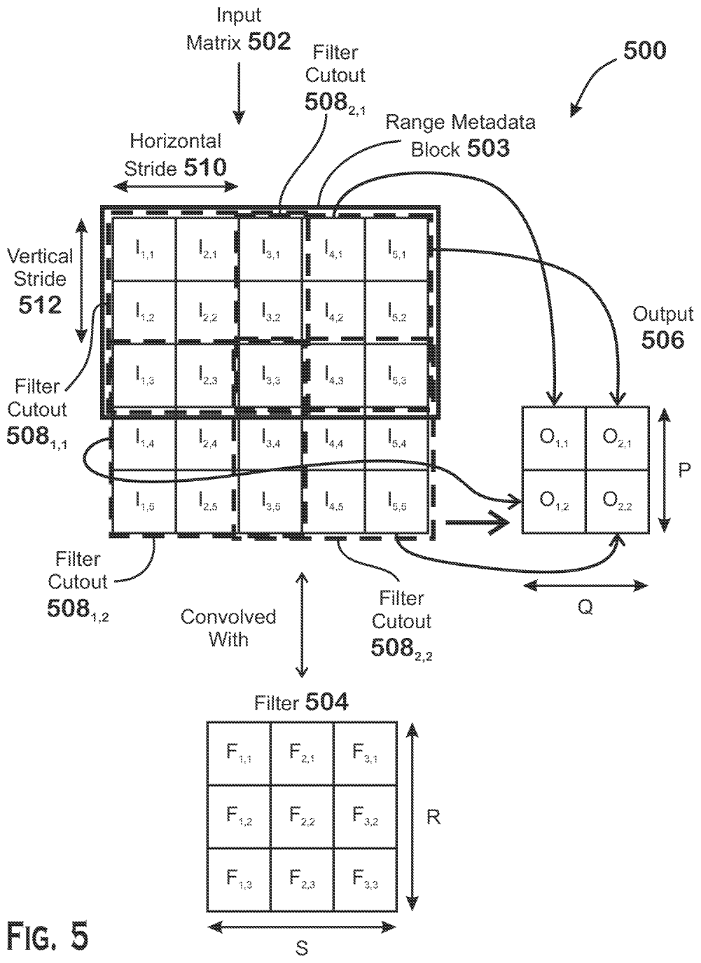

Another type of neural network operation that is implemented with matrix multiplication is convolutions. FIG. 5 illustrates a convolution operation 500, according to an example. In the convolution operation, an input matrix 502 (such as an image or other matrix data) is convolved with a filter 504 to generate an output matrix 506. Within the input matrix 502, several filter cutouts 508 are shown. Each filter cutout represents a portion of the input matrix 502 for which a dot product is performed with the filter 504 to generate an element O of the output matrix 506. Note, the operation for each filter cutout is not a matrix multiplication, but a dot product, with two vectors that are generated by laying out the elements of the filter cutout and the filter as one-dimensional vectors. Thus, output element O_{1,1} is equal to I_{1,1}F_{1,1}+I_{2,1}++I_{2,1}F_{3,1}+I_{1,2}F_{1,2} . . . +I_{2,3}F_{2,3}+I_{3,3}F_{3,3}. The filter 504 has dimensions S by R and the output matrix 506 has dimensions Q by P as shown.

The location of the filter cutouts 508 is defined by the horizontal stride 510 and the vertical stride 512. More specifically, the first filter cutout 508 is located in the top left corner and the horizontal stride 510 defines the number of input matrix elements in the horizontal direction by which each subsequent filter cutout 508 is offset from the previous filter cutout. Filter cutouts 508 that are horizontally aligned (i.e., all elements are in exactly the same rows) are referred to herein as a filter cutout row. The vertical stride 512 defines the number of input matrix elements in the vertical direction by which each filter cutout row is offset from the previous filter cutout row.

In one example, conversion of a convolution operation to a matrix multiplication operation is performed as follows. Each filter cutout is laid out as elements of a row for placement into an input multiplicand matrix. These rows are stacked vertically, so that the input matrix is a set of rows, with each row corresponding to a different filter cutout, and each row containing the elements of that filter cutout. The filter data is arrayed vertically to form a filter vector. This allows matrix multiplication of the input data by the filter vector to result in the output image 506, since such matrix multiplication involves performing a dot product of each filter cutout 508 with the filter data to generate an output element of the output image 506. Note that the output of this matrix multiplication will be a vector and not a 2-dimensional image, but this vector can be easily rearranged into the appropriate format or just treated as if the vector were in the appropriate format as necessary.

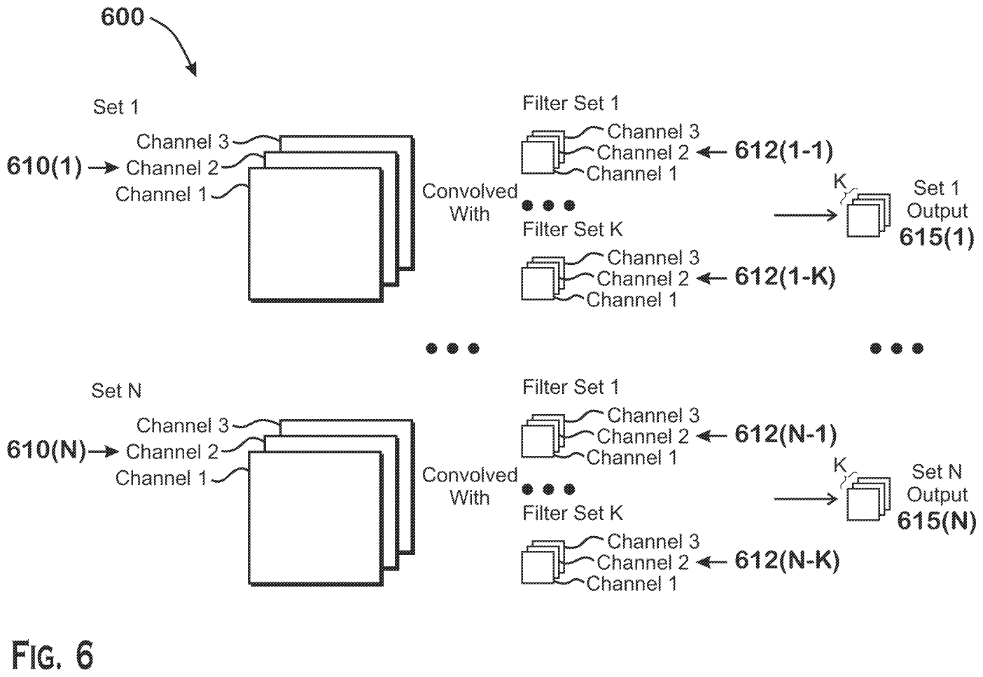

FIG. 6 illustrates a batched, multi-channel convolution operation 600, according to an example. In a batched, multi-channel convolution operation, N input sets 610 are each convolved with K filter sets 612, where each input set 610 and each filter set 612 has C channels each. The output produced is N output sets 615, each output set 615 having K output images.

In a multi-channel convolution operation, there are multiple input images 502 and multiple filters 504, where each input image 502 and each filter 504 is associated with a specific channel. The multi-channel convolution involves convolving the input image of a particular channel with the filter of that same channel. Doing these multiple convolution operations for each channel results in an output image for each channel. These output images are then summed to obtain the final output image for the convolution, for a particular input set 610 and a particular filter set 612. The output image is generated for each input set 610 K times, to generate an output set 615 for a given input set 610. The total output 606 is N output sets 615, where each output set includes K output images. Thus, the total number of output images is K×N, since K output images are produced for each input set 610 and there are K filter sets 612.

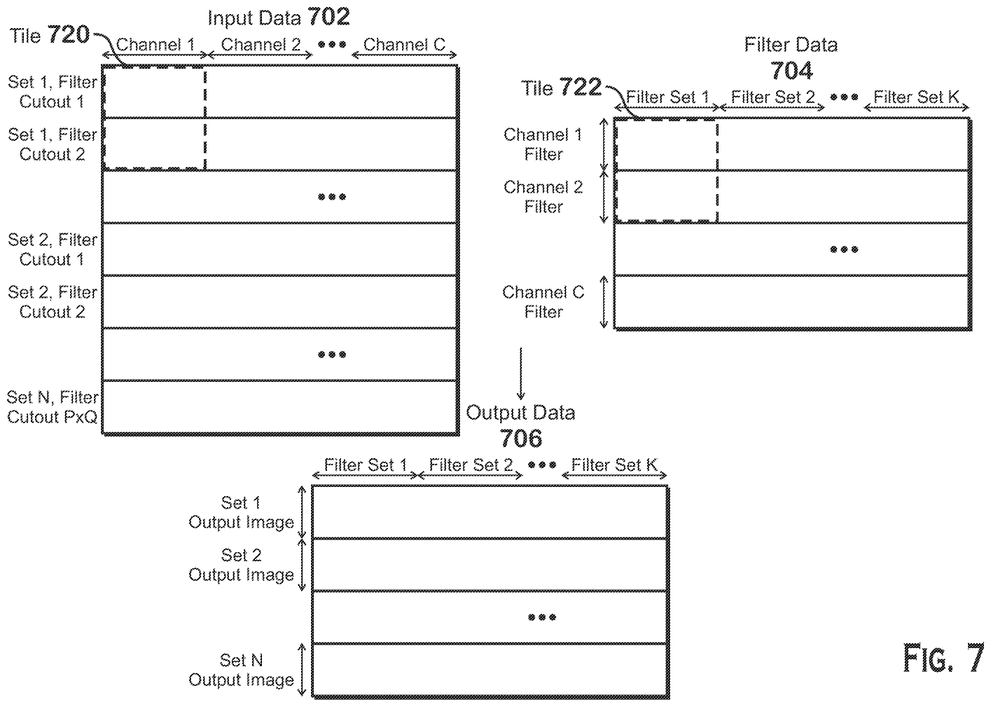

FIG. 7 illustrates an example way in which a multi-channel, batched convolution is performed as a matrix multiplication operation. Note that although this example is described for multiple channels, multiple input images (N) and multiple filter sets (K), the teachings presented herein apply to unbatched convolutions, or convolutions that include one input image (N=1), one filter set (K=1), and/or one channel (C=1).

The input data 702 includes data for C channels, N input sets 610, and P×Q filter cutouts. There are P×Q filter cutouts per input set 610, because an output image 506 has P×Q elements, and each such element is generated using a dot product of one filter cutout with a filter. The filter cutouts are arrayed as rows in the input data 702. A single row in the input data 702 includes all channels arrayed horizontally for a particular filter cutout from a particular input set 610. Thus there are N×P×Q rows in the input data 702, with each row including filter cutout data for all channels and for a particular input image set 610 and a particular filter cutout.

The filter data 704 includes K filter sets, each filter set 612 having C filters each (one for each channel). Each filter includes the data for one channel of one of the K filter sets 612. The data for individual filters is arranged vertically, with the data for all channels of a single filter set 612 belonging in one column and a total of K columns existing in the filter data 704.

The output matrix 706 includes N output images for each of the K filter sets. The output matrix 706 is generated as a normal matrix multiplication operation of the input data 702 and the filter data 704. To perform this operation in a tiled manner, the tile matrix multiplier 302 generates tiles in each of the input data 702 and the filter data 704, multiplies those tiles together to generate partial matrix products, and adds those partial matrix products together in the manner described elsewhere herein with regards to multiplying “coarse” matrices whose elements are the tiles. An input tile 720 and a filter data tile 722 are shown to illustrate how a tile might be formed from the input data 702 and filter data 704, although these tiles could be of any size.

The multiplication generates the output data in the following manner. Each row of the input data 702 is vector-multiplied by each column of the filter data 704 to generate an element of the output image 706. This vector-multiplication corresponds to the dot product of all channels of a particular filter cutout with a particular filter set. Note that because the channel convolution outputs are summed to generate an output for a given input batch and filter set, the above dot product works to generate such an output. A corresponding vector product is completed for each input set and each filter set, to generate output data 706.

Note that it is possible for the input data 702 to include duplicate data. More specifically, referring momentarily back to FIG. 5, filter cutout 508_{1,1} and filter cutout 508_{2,1} share input matrix elements I_{3,1}, I_{3,2}, and I_{3,3}. Moreover, referring back to FIG. 7, in many situations, the tiles 720 of the input data are generated on the fly. For these reasons, in some implementations, the layer input range metadata 310 is stored on a per-range metadata block 503 basis, rather than on a per-input data tile 720 basis. A range metadata block 503 is a portion of an input image 502 from which input image tiles 720 are generated. All input image tiles 720 generated from a particular range metadata block 503 is assigned the range of the range metadata block 503. If an input image tile 720 is generated from multiple range metadata blocks 503, then such a tile 720 is assigned the widest range out of the ranges of those multiple range metadata blocks 503. This configuration reduces the number of times that layer input range metadata 310 needs to be determined, as this configuration allows all input data tiles 720 generated from a single range metadata block 503 to use the range metadata stored for that range metadata block 503.

A range metadata block includes multiple filter cutouts 508. In some examples, a range metadata block 503 includes an entire filter cutout row or multiple filter cutout rows.

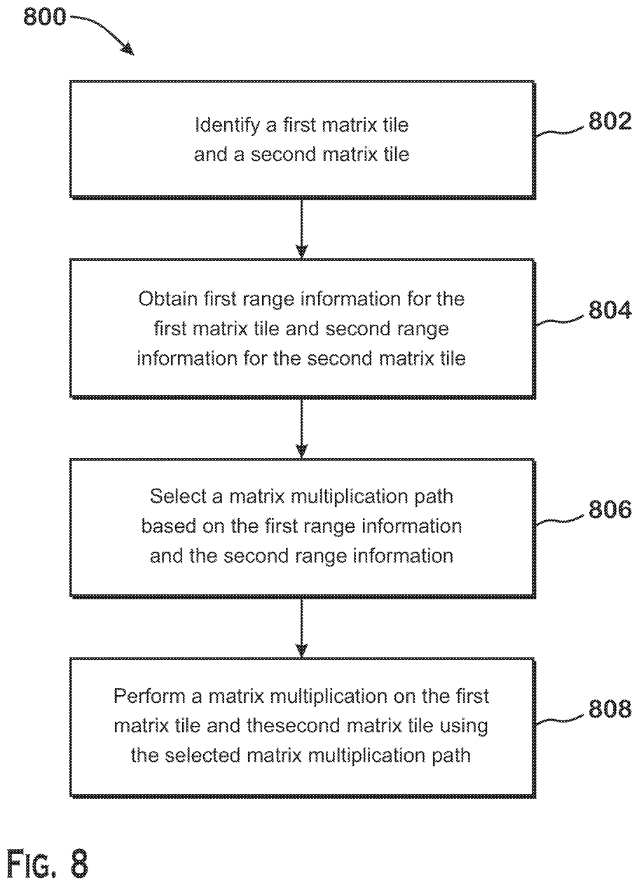

FIG. 8 is a flow diagram of a method 800 for performing matrix operations, according to an example. Although described with respect to the system of FIGS. 1-7, those of skill in the art will understand that any system configured to perform the steps of method 800 in any technically feasible order falls within the scope of the present disclosure.

The method 800 begins at step 802, where a tile matrix multiplier 302 identifies a first tile and a second tile to multiply together. In various implementations, the first tile is a tile of a first matrix to be multiplied and the second tile is a tile of a second matrix that is to be multiplied by the first matrix. In some implementations, a tile of a matrix is a sub-matrix of that matrix, containing a subset of the elements of that matrix. More specifically, it is possible to obtain the result of a matrix multiplication of two large matrices by dividing one or both such matrices into tiles, and multiplying those tiles together in an order similar to the standard matrix multiplication element order (i.e., obtain a dot product of each row and each column), as described elsewhere herein. This allows matrix multiplication circuitry configured for a relatively small size of matrices to be used to multiply larger matrices together.

At step 804, the tile matrix multiplier 302 obtains first range information for the first matrix tile and second range information for the second matrix tile. The first range information indicates a range into which all elements of the first matrix tile fit and the second range information indicates a range into which all elements of the second matrix tile fit.

At step 806, the tile matrix multiplier 302 selects a matrix multiplication path 306 based on the first range information and the second range information. Different multiplication paths 306 are configured for different combinations of ranges. Multiplication paths 306 that are configured for a combination of wider ranges are more complex and consume more power than multiplication paths 306 that are configured for a combination of narrower ranges. Thus, using the range information to select a multiplication path 306 for different tile-by-tile multiplications reduces the amount of power used overall.

In some implementations, multiplication paths 306 for more limited ranges are simpler than multiplication paths 306 for wider ranges because multiplication paths 306 for more limited ranges include less circuitry for comparing the exponent values of partial matrix products when determining which such partial matrix products to discard when summing those partial matrix products. More specifically, matrix multiplication involves performing dot products, which involves summing multiplication products. With floating point addition, addition between two numbers may involve simply discarding a number for being too small, and this discard is performed in response to a comparison between exponent magnitudes. With a very wide range of numbers in matrix multiplication, a larger number of such exponent comparisons are made, which requires additional specific circuitry. Therefore, multiplication paths 306 for more limited ranges are implemented with a smaller amount of circuitry and thus consume less power than multiplication paths 306 for wider ranges.

At step 808, the selected multiplication path 306 performs the matrix multiplication for the first tile and the second tile.

In some examples, the method 800 also includes detecting the range information for the first tile and the second tile. In some examples, the first tile and second tile are tiles of matrices that are used to implement a layer 202 of a neural network 104. In response to the output from a previous layer 202 being generated, the neural network processing block 102 generates the range information based on that output and stores that range information in a memory that stores the range metadata.

In some examples, the layer for which matrix multiplication is performed is a general neuron layer such as the layer 402 illustrated in FIG. 4. In this example, the neural network processing block 102 examines the input to that layer 402, which includes a vector of neuron inputs from a previous layer 402, generates tiles based on that data, and determines the range information for those tiles. In some implementations, the tiles are part of a matrix that includes batched neuron input, as illustrated in FIG. 4. In such batched input, the first matrix includes a vector of neuron input values for each of several input sets. Sets are independent data processed through the neural network 104.

In some examples, the layer for which matrix multiplication is performed is a convolutional layer. The input matrices include input data 702 and filter data 704 as described in FIG. 7. However, this input is provided in the form of input images 502, illustrated in FIG. 5. The neural network processing block 102 determines the ranges for the range metadata blocks 503 of the input images and processes such convolutional layer as described elsewhere herein (for example with respect to FIGS. 5-7).

It should be understood that many variations are possible based on the disclosure herein. Although features and elements are described above in particular combinations, each feature or element may be used alone without the other features and elements or in various combinations with or without other features and elements.

The various functional units illustrated in the figures and/or described herein (including, where appropriate, the neural network processing block 102 and the tile matrix multiplier 302) may be implemented as hardware circuitry, software executing on a programmable processor, or a combination of hardware and software. The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for performing neural network operations, the method comprising:
identifying a first matrix tile and a second matrix tile;
obtaining first range information for the first matrix tile and second range information for the second matrix tile;
selecting a matrix multiplication path based on the first range information and the second range information; and
performing a matrix multiplication on the first matrix tile and the second matrix tile using the selected matrix multiplication path to generate a tile matrix multiplication product.

2. The method of claim 1, wherein:
the first tile is a portion of an input to a layer of a neural network and the second tile is a portion of a weight matrix for the layer of the neural network.

3. The method of claim 2, further comprising:
automatically generating the first range information by analyzing input to the layer.

4. The method of claim 1, wherein selecting the matrix multiplication path comprises selecting the matrix multiplication path from a set of two or more matrix multiplication paths, wherein each matrix multiplication path is configured to perform a matrix multiplication operation for a different set of input ranges.

5. The method of claim 2, wherein the layer comprises a generic neuron layer.

6. The method of claim 5, wherein the matrix multiplication of the first matrix tile and the second matrix tile comprises a portion of a batched generic neuron layer operation.

7. The method of claim 2, wherein the layer comprises a convolutional layer.

8. The method of claim 7, wherein range information is stored for a set of range metadata blocks that include multiple filter cutouts.

9. The method of claim 8, wherein obtaining the first range information comprises retrieving a range for a range metadata block from which the first tile is generated.

10. A system for performing neural network operations, the system comprising:
a set of matrix multiplication paths; and
a tile matrix multiplier, configured to:
identify a first matrix tile and a second matrix tile;
obtain first range information for the first matrix tile and second range information for the second matrix tile;
select a matrix multiplication path, of the set of multiplication paths, based on the first range information and the second range information; and
perform a matrix multiplication on the first matrix tile and the second matrix tile using the selected matrix multiplication path to generate a tile matrix multiplication product.

11. The system of claim 10, wherein:
the first tile is a portion of an input to a layer of a neural network and the second tile is a portion of a weight matrix for the layer of the neural network.

12. The system of claim 11, further comprising:
a neural network processing block configured to automatically generate the first range information from analyzing input to the layer.

13. The system of claim 11, wherein each matrix multiplication path is configured to perform a matrix multiplication operation for a different set of input ranges.

14. The system of claim 11, wherein the layer comprises a generic neuron layer.

15. The system of claim 14, wherein the matrix multiplication of the first matrix tile and the second matrix tile comprises a portion of a batched generic neuron layer operation.

16. The system of claim 11, wherein the layer comprises a convolutional layer.

17. The system of claim 16, wherein range information is stored for a set of range metadata blocks that include multiple filter cutouts.

18. The system of claim 17, wherein obtaining the first range information comprises retrieving a range for a range metadata block from which the first tile is generated.

19. A non-transitory computer-readable medium storing instructions that, when executed by a processor, cause the processor to:
identify a first matrix tile and a second matrix tile;
obtain first range information for the first matrix tile and second range information for the second matrix tile;
select a matrix multiplication path based on the first range information and the second range information; and
performing a matrix multiplication on the first matrix tile and the second matrix tile using the selected matrix multiplication path to generate a tile matrix multiplication product.

20. The non-transitory computer-readable medium of claim 19, wherein selecting the matrix multiplication path comprises selecting the matrix multiplication path from a set of two or more matrix multiplication paths, wherein each matrix multiplication path is configured to perform a matrix multiplication operation for a different set of input ranges.
